(19) United States
(12) Patent Application Publication
(10) Pub. No.: US 2023/0281609 A1
(43) Pub. Date: Sep. 7, 2023

(54) ELECTRONIC RESOURCE TRANSFER PLATFORM UTILIZING A MULTI-PATH RECOMMENDATION ENGINE

(71) Applicant: BANK OF AMERICA CORPORATION, Charlotte, NC (US)

(72) Inventors: Prashant Khare, Mumbai (IN); Raman Natarajan, Hyderabad (IN); Bhaskar Pratap Swain, Hyderabad (IN)

(73) Assignee: BANK OF AMERICA CORPORATION, Charlotte, NC (US)

(21) Appl. No.: 17/683,642

(22) Filed: Mar. 1, 2022

(51) Int. Cl. G06Q 20/36

(52) U.S. Cl. CPC G06Q 20/3678

(57) ABSTRACT

Systems, computer program products, and methods are described herein for an electronic resource transfer platform utilizing a multi-path recommendation engine in blockchain. The present invention may be configured to receive a request from a user to transfer resources, generate a first block comprising the user request, and record the first block on a distributed ledger. The present invention may also be configured to receive resource transfer quotes from an entity or entities. The present invention may also be configured to utilize a recursive auto-recommendation engine to provide recommended resource transfer quotes to the user. Further, the present invention may be configured to generate a smart contract, establish a consensus, and settle the resource transfer after receiving a selection of a resource transfer quote from the user. The present invention may be further configured to generate a second block comprising resource transfer data and store the second block on the distributed ledger.

### FIELD OF THE INVENTION

The present invention embraces an electronic resource transfer platform and system that utilizes a multi-path recommendation engine.

### BACKGROUND

Currently, when a user wishes to perform a resource transfer or transaction, the user is limited to the services provided by the entities that the user already has a relationship with. This may lead to a user potentially not receiving the best service for their specific purpose. A need exists for a system that combines a multiple entity approach to selecting a resource transfer service.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. This summary presents some concepts of one or more embodiments of the present invention in a simplified form as a prelude to the more detailed description that is presented later.

In one aspect, a system for electronic resource transfer is presented. The system may include at least one non-transitory storage device and at least one processing device coupled to the at least one non-transitory storage device, where the at least one processing device may be configured to receive a request, from a user, to transfer resources. The at least one processing device may be further configured to create a first block comprising the request data, wherein the first block is stored on a distributed ledger. The at least one processing device may be further configured to receive resource transfer quotes from at least one entity. The at least one processing device may be further configured to provide recommendations to the user. The recommendations comprise at least one of the resource transfer quotes provided by the entity or entities. The recommendations are generated by a recursive auto-recommender engine. The recursive auto-recommender engine may be stored on an auto-recommender node within the distributed ledger. The at least one processing device may be further configured to receive a resource transfer quote selection from the user and generate a smart contract that is stored on the distributed ledger. The at least one processing device may be further configured to establish a consensus amongst nodes of the distributed ledger, after which the system will receive settlement instructions from the user, settle the resource, and create a second block for storage on the distributed ledger comprising the resource transfer data. In some embodiments, the at least one processing device may be further configured to develop a user characterization.

In another aspect, a computer program product for electronic resource transfer is presented. The computer program product may include a non-transitory computer-readable medium including code causing a first apparatus to receive a request, from a user, to transfer resources. The non-transitory computer-readable medium may include code causing the first apparatus to create a first block comprising the request data, wherein the first block is stored on a distributed ledger. The non-transitory computer-readable medium may include code causing a first apparatus to receive resource transfer quotes from at least one entity. The non-transitory computer-readable medium may include code causing the first apparatus to provide recommendations to the user. The recommendations comprise at least one of the resource transfer quotes provided by the entity or entities. The recommendations are generated by a recursive auto-recommender engine. The recursive auto-recommender engine may be stored on an auto-recommender node within the distributed ledger. The non-transitory computer-readable medium may include code causing the first apparatus to receive a resource transfer quote selection from the user and generate a smart contract that is stored on the distributed ledger. The non-transitory computer-readable medium may include code causing the first apparatus to establish a consensus amongst nodes of the distributed ledger, after which the system will receive settlement instructions from the user, settle the resource, and create a second block for storage on the distributed ledger comprising the resource transfer data. In some embodiments, the non-transitory computer-readable medium may include code causing the first apparatus to develop a user characterization.

In yet another aspect, a method for electronic resource transfer is provided. The method may include receiving a request, from a user, to transfer resources. The method may further include creating a first block comprising the request data, wherein the first block is stored on a distributed ledger. The method may further include receiving resource transfer quotes from at least one entity. The method may further include providing recommendations to the user. The recommendations comprise at least one of the resource transfer quotes provided by the entity or entities. The recommendations are generated by a recursive auto-recommender engine. The recursive auto-recommender engine may be stored on an auto-recommender node within the distributed ledger. The method may further include receiving a resource transfer quote selection from the user and generate a smart contract that is stored on the distributed ledger. The method may further include establishing a consensus amongst nodes of the distributed ledger, receiving settlement instructions from the user, settling the resource, and creating a second block for storage on the distributed ledger comprising the resource transfer data. In some embodiments, method may further include developing a user characterization.

In some embodiments, the recursive auto-recommender engine utilizes a content-based filtering model. Additionally, or alternatively, the recursive auto-recommender engine utilizes a collaborative-based filtering model. In some embodiments, the recursive auto-recommender engine utilizes a hybrid filtering model. In some embodiments, the recursive auto-recommender engine evaluates accuracy of each filtering model using historical data. In some embodiments, the auto-recommender node comprises at least one of a user database and a quotation database. Additionally, or alternatively, the auto-recommender node utilizes quantum computing.

In some embodiments, the resource transfer data comprises an amount, an origination, and a destination.

In some embodiments, the resource transfer quote comprises a settlement rate. Additionally, or alternatively, the resource transfer quote comprises a settlement time. In some embodiments, the resource transfer quote comprises an expiration date.

### BRIEF DESCRIPTION OF THE DRAWINGS

Having thus described embodiments of the invention in general terms, reference will now be made the accompanying drawings, wherein:

FIG. 1 illustrates technical components of a system for electronic resource transfer, in accordance with an embodiment of the invention;

FIG. 2 illustrates a process flow for electronic resource transfer, in accordance with an embodiment of the invention;

FIG. 3 illustrates a flow diagram for electronic resource transfer, in accordance with previous electronic resource transfer systems;

FIG. 4 illustrates a flow diagram for electronic resource transfer, in accordance with an embodiment of the invention;

FIG. 5 illustrates a flow diagram for providing real-time quotations, in accordance with an embodiment of the invention;

FIG. 6 illustrates a flow diagram for electronic resource settlement, in accordance with an embodiment of the invention; and

FIG. 7 illustrates an exemplary schematic for an auto-recommender node, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As noted, current resource transfer platforms provide users with the ability to book resource transfers with entities with which they have a current relationship. Current platforms do not have the infrastructure to perform instant settlements for users without a pre-existing relationship. Due to this shortcoming, there is little to no transparency for the user to choose the best resource transfer solution for their needs.

The present invention provides a system and an intelligent platform for resource transfer based on distributed ledger technology. The present invention also provides for an artificially intelligent (AI) auto-recommender engine (e.g., a recursive auto-recommender engine) that operates inside the distributed ledger. The AI auto-recommender engine can automatically create real-time multiple recommendation models using distributed ledger data and quantum computing to recommend the best resource transfer option for the user. The auto-recommender engine comprises a database, or databases, storing various parameters. Parameters may include, user report details, entity report details, resource transfer rates, settlement times, resource transfer rate validity, validity of smart contract, feedback from users about entities, and feedback from entities about users. The auto-recommender system utilizes use collaborative filtering, content-based filtering, and a hybrid system to determine recommendations for the user’s resource transfer. The auto-recommender system performs a self-evaluation to each model using historical data to determine which recommendation model is best for each particular resource transfer.

Once a user requests access to the platform, the system will perform a KYC (know-your-client)-analysis for the user. After this, the user may request a resource transfer. The system will create a block containing user request details and store the block on the distributed ledger. Once a consensus is established between the user and the platform, the platform will receive real-time quotes from various entities. The real-time quotes will be process via the AI auto-recommender engine to recommend the best quotes to the user. The AI auto-recommender engine may utilize multiple filtering methods and recommendation models. The AI auto-recommender engine would suggest different options to the user based on various parameters of the resource transfer. For example, the parameters may include a rate, an expiration date, a timeframe, entity trust rating, etc. The recommendations will be presented to the user through the distributed ledger network so that the user can select the best resource transfer for their needs. Once a user selects the resource transfer that best fits their needs, the system will generate a smart contract, between the two parties. The smart contract will be signed by both parties, entity and user. Smart contracts should be accepted by all nodes in a distributed ledger. The system will confirm receipt of a consensus request by all nodes within the distributed ledger prior to establishing a consensus. Once the consensus is established the smart contract is confirmed and added to the distributed ledger as an active block. If a consensus is not reached, then a passive block would be added to the distributed ledger for consistency purposes. At this point, the system will send the user’s settlement instructions to a settlement system to settle the resource transfer. In some embodiments, the settlement instructions must be validated by payment validation rules. Settlement may occur automatically or manually. Once settled, an active block will be added to the distributed ledger to document a complete settlement of the resource transfer.

As used herein, an “entity” may be any institution employing information technology resources and particularly technology infrastructure configured for processing large amounts of data. Typically, the data may be related to products, services, and/or the like offered and/or provided by the entity, customers of the entity, other aspect of the operations of the entity, people who work for the entity, and/or the like. As such, the entity may be an institution, group, association, financial institution, establishment, company, union, authority, merchant, service provider, and/or the like employing information technology resources for processing large amounts of data. In some embodiments, the entity may be an institution, group, association, financial institution, establishment, company, union, authority, merchant, service provider, and/or the like hosting, sponsoring, coordinating, creating, and/or the like events, recognitions, achievements, and/or the like.

As used herein, a “user” may be an individual associated with an entity. As such, in some embodiments, the user may be an individual having past relationships, current relationships or potential future relationships with an entity. In some embodiments, a “user” may be an employee (e.g., an associate, a project manager, a manager, an administrator, an internal operations analyst, and/or the like) of the entity and/or enterprises affiliated with the entity, capable of operating systems described herein. In some embodiments, a “user” may be any individual, another entity, and/or a system who has a relationship with the entity, such as a customer, a prospective customer, and/or the like. In some embodiments, a user may be a system performing one or more tasks described herein. In some embodiments, a user may be a verified authority as described herein.

As used herein, a “user interface” may be any device or software that allows a user to input information, such as commands and/or data, into a device, and/or that allows the device to output information to the user. For example, a user interface may include an application programmer interface (API), a graphical user interface (GUI), and/or an interface to input computer-executable instructions that direct a processing device to carry out functions. The user interface may employ input and/or output devices to input data received from a user and/or output data to a user. Input devices and/or output devices may include a display, API, mouse, keyboard, button, touchpad, touch screen, microphone, speaker, LED, light, joystick, switch, buzzer, bell, and/or other devices for communicating with one or more users.

As used herein, a “resource” may generally refer to objects, products, devices, goods, commodities, services, offers, discounts, currency, cash, cash equivalents, rewards, reward points, benefit rewards, bonus miles, cash back, credits, and/or the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, and/or the like.

As used herein, a “source retainer” may generally refer to an account, a system, and/or the like associated with a user and/or a type of resources, such as software, a checking account, a deposit account, a savings account, a credit account, a rewards account, a rewards points account, a benefit rewards account, a bonus miles account, a cash back account, and/or the like, which may be managed and/or maintained by an entity, such as a financial institution, an electronic resource transfer institution (e.g., a credit card company, a debit card company, a prepaid card company, and/or the like), a credit union, and/or the like.

As used herein, a “distribution” and/or an “allocation” may refer to any transaction, activities, and/or communication between one or more entities, between a user and one or more entities, and/or the like. A resource distribution and/or an allocation of resources may refer to any distribution of resources such as, but not limited to, a payment, processing of funds, purchase of goods or services, a return of goods or services, a payment transaction, a credit transaction, other interactions involving a user’s resource or account, and/or the like. In the context of an entity such as a financial institution, a resource distribution and/or an allocation of resources may refer to one or more of a sale of goods and/or services, initiating an automated teller machine (ATM) or online financial session, an account balance inquiry, a rewards transfer, an account money transfer or withdrawal, opening a financial application on a user’s computer or mobile device, a user accessing their e-wallet, any other interaction involving the user and/or the user’s device that invokes and/or is detectable by the financial institution, and/or the like. In some embodiments, the user may authorize a resource distribution and/or an allocation of resources using a resource distribution instrument (e.g., credit cards, debit cards, checks, digital wallets, currency, loyalty points, and/or the like) and/or resource distribution credentials (e.g., account numbers, resource distribution instrument identifiers, and/or the like). A resource distribution and/or an allocation of resources may include one or more of the following: renting, selling, and/or leasing goods and/or services (e.g., groceries, stamps, tickets, DVDs, vending machine items, and/or the like); making payments to creditors (e.g., paying monthly bills; paying federal, state, and/or local taxes; and/or the like); sending remittances; loading money onto stored value cards (SVCs) and/or prepaid cards; donating to charities; and/or the like. Unless specifically limited by the context, a “resource distribution,” an “allocation of resources,” a “resource transfer,” a “transaction,” a “transaction event,” and/or a “point of transaction event” may refer to any activity between a user, a merchant, an entity, and/or the like. In some embodiments, a resource distribution and/or an allocation of resources may refer to financial transactions involving direct or indirect movement of funds through traditional paper transaction processing systems (e.g., paper check processing) or through electronic transaction processing systems. In this regard, resource distributions and/or allocations of resources may refer to the user initiating a purchase for a product, service, or the like from a merchant. Typical financial resource distribution and/or financial allocations of resources include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points, and/or the like. When describing that resource transfers or transactions are evaluated, such descriptions may mean that the transaction has already occurred, is in the process of occurring or being processed, or has yet to be processed/posted by one or more financial institutions.

As used herein, “resource distribution instrument” may refer to an electronic payment vehicle, such as an electronic credit, debit card, and/or the like, associated with a source retainer (e.g., a checking account, a deposit account, a savings account, a credit account, and/or the like). In some embodiments, the resource distribution instrument may not be a “card” and may instead be account identifying information stored electronically in a user device, such as payment credentials and/or tokens and/or aliases associated with a digital wallet, account identifiers stored by a mobile application, and/or the like.

In some embodiments, the term “module” with respect to an apparatus may refer to a hardware component of the apparatus, a software component of the apparatus, and/or a component of the apparatus that includes both hardware and software. In some embodiments, the term “chip” may refer to an integrated circuit, a microprocessor, a system-on-a-chip, a microcontroller, and/or the like that may either be integrated into the external apparatus, may be inserted and/or removed from the external apparatus by a user, and/or the like.

As used herein, an “engine” may refer to core elements of a computer program, part of a computer program that serves as a foundation for a larger piece of software and drives the functionality of the software, and/or the like. An engine may be self-contained but may include externally controllable code that encapsulates powerful logic designed to perform or execute a specific type of function. In one aspect, an engine may be underlying source code that establishes file hierarchy, input and/or output methods, how a part of a computer program interacts and/or communicates with other software and/or hardware, and/or the like. The components of an engine may vary based on the needs of the computer program as part of the larger piece of software. In some embodiments, an engine may be configured to retrieve resources created in other computer programs, which may then be ported into the engine for use during specific operational aspects of the engine. An engine may be configurable to be implemented within any general-purpose computing system. In doing so, the engine may be configured to execute source code embedded therein to control specific features of the general-purpose computing system to execute specific computing operations, thereby transforming the general-purpose system into a specific purpose computing system.

As used herein, a “component” of an application may include a software package, a service, a resource, a module, and/or the like that includes a set of related functions and/or data. In some embodiments, a component may provide a source capability (e.g., a function, a business function, and/or the like) to an application including the component. In some embodiments, components of an application may communicate with each other via interfaces and may provide information to each other indicative of the services and/or functions that other components may utilize and/or how other components may utilize the services and/or functions. Additionally, or alternatively, components of an application may be substitutable such that a component may replace another component. In some embodiments, components may include objects, collections of objects, and/or the like.

As used herein, “authentication credentials” may be any information that may be used to identify a user. For example, a system may prompt a user to enter authentication information such as a username, a password, a token, a personal identification number (PIN), a passcode, biometric information (e.g., voice authentication, a fingerprint, and/or a retina scan), an answer to a security question, a unique intrinsic user activity, such as making a predefined motion with a user device, and/or the like. The authentication information may be used to authenticate the identity of the user (e.g., determine that the authentication information is associated with an account) and/or determine that the user has authority to access an account or system. In some embodiments, the system may be owned and/or operated by an entity. In such embodiments, the entity may employ additional computer systems, such as authentication servers, to validate and certify resources inputted by a plurality of users within the system. The system may further use authentication servers to certify the identity of users of the system, such that other users may verify the identity of the certified users. In some embodiments, the entity may certify the identity of the users. Furthermore, authentication information and/or permission may be assigned to and/or required from a user, application, computing node, computing cluster, and/or the like to access stored data within at least a portion of the system.

As used herein, an “interaction” may refer to any communication between one or more users, one or more entities or institutions, and/or one or more devices, nodes, clusters, and/or systems within the system environment described herein. For example, an interaction may refer to a transfer of data between devices, an accessing of stored data by one or more nodes of a computing cluster, a transmission of a requested task, and/or the like. In some embodiments, an interaction may refer to an entity, a user, a system, and/or a device providing an advertisement, information, data, a user interface, and/or the like to another entity, another user, another system, and/or another device.

As used herein, identifiers such as “first,” “second,” “third,” and/or the like do not indicate a temporal relationship, unless explicitly stated. Such identifiers may modify instances of similar things and may be used to differentiate between each of the instances.

As used herein, a “subset” may refer to one or more from a group. For example, a subset of users from a group of users may be one user from the group of users, multiple users from the group of users, or all of the users from the group of users. As another example, a subset of properties may be one property from the properties, multiple properties from the properties, or all of the properties.

As used herein, a “smart contract” may refer to computer program or transaction protocol for a self-executing contract wherein the terms between two parties are written into the code. The code, and the terms of the smart contract, are stored on a distributed ledger. The code controls the execution of the contract. The terms, and transactions of the smart contract are trackable and irreversible.

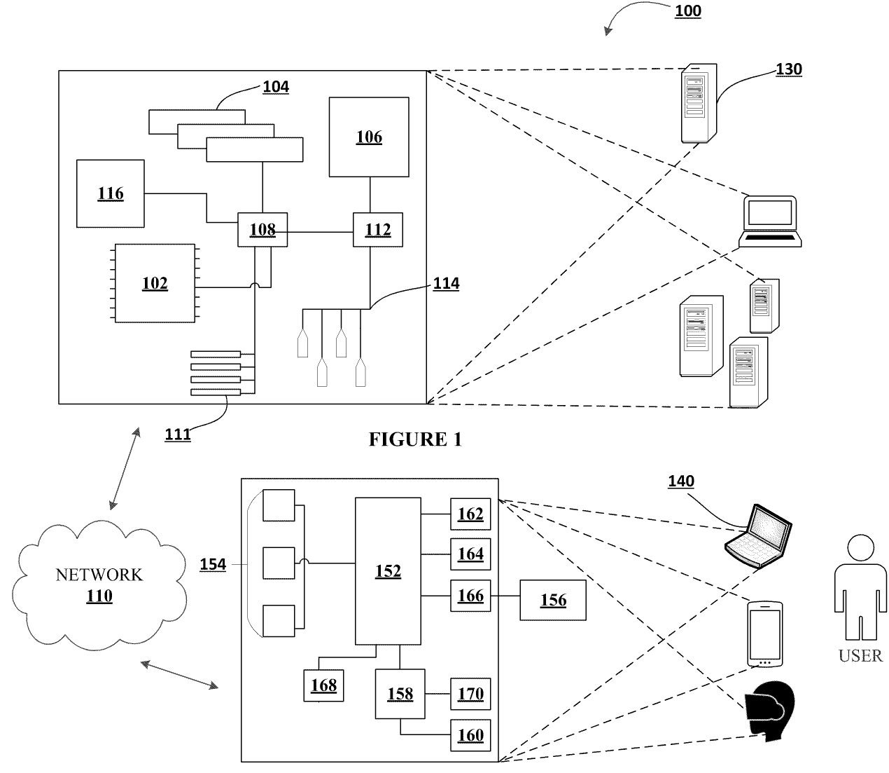

FIG. 1 presents an exemplary block diagram of a system environment 100 for electronic resource transfer, in accordance with an embodiment of the invention. FIG. 1 provides a system environment 100 that includes specialized servers and a system communicably linked across a distributive network of nodes required to perform functions of process flows described herein in accordance with embodiments of the present invention.

As illustrated, the system environment 100 includes a network 110, a system 130, and a user input system 140. Also shown in FIG. 1 is a user of the user input system 140. The user input system 140 may be a mobile device, a non-mobile computing device, and/or the like. The user may be a person who uses the user input system 140 to access, view modify, interact with, and/or the like information, data, images, video, and/or the like. The user may be a person who uses the user input system 140 to initiate, perform, monitor, and/or the like changes and/or modifications to one or more systems, applications, services, and/or the like. The one or more systems, applications, services, and/or the like may be configured to communicate with the system 130, input information onto a user interface presented on the user input system 140, and/or the like. The applications stored on the user input system 140 and the system 130 may incorporate one or more parts of any process flow described herein.

As shown in FIG. 1, the system 130 and the user input system 140 are each operatively and selectively connected to the network 110, which may include one or more separate networks. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology.

In some embodiments, the system 130 and the user input system 140 may be used to implement processes described herein, including user-side and server-side processes for electronic resource transfers, in accordance with an embodiment of the present invention. The system 130 may represent various forms of digital computers, such as laptops, desktops, workstations, personal digital assistants, servers, blade servers, mainframes, and/or the like. The user input system 140 may represent various forms of mobile devices, such as personal digital assistants, cellular telephones, smartphones, smart glasses, and/or the like. The components shown here, their connections, their relationships, and/or their functions, are meant to be exemplary only, and are not meant to limit implementations of the inventions described and/or claimed in this document.

In some embodiments, the system 130 may include a processor 102, memory 104, a storage device 106, a high-speed interface 108 connecting to memory 104, high-speed expansion ports 111, and a low-speed interface 112 connecting to low-speed bus 114 and storage device 106. Each of the components 102, 104, 106, 108, 111, and 112 may be interconnected using various buses, and may be mounted on a common motherboard or in other manners as appropriate. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130 may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a card management institution, a software and/or hardware development company, a software and/or hardware testing company, and/or the like. The system 130 may be located at a facility associated with the entity and/or remotely from the facility associated with the entity.

The memory 104 may store information within the system 130. In one implementation, the memory 104 may be a volatile memory unit or units, such as volatile random-access memory (RAM) having a cache area for the temporary storage of information. In another implementation, the memory 104 may be a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 may be capable of providing mass storage for the system 130. In one aspect, the storage device 106 may be or contain a computer-readable medium, such as a floppy disk device, a hard disk device, an optical disk device, a tape device, a flash memory and/or other similar solid state memory device, and/or an array of devices, including devices in a storage area network or other configurations. A computer program product may be tangibly embodied in an information carrier. The computer program product may also contain instructions that, when executed, perform one or more methods, such as those described herein. The information carrier may be a non-transitory computer-readable or machine-readable storage medium, such as the memory 104, the storage device 106, and/or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application and allows memory reuse for better utilization of the memory resources when the data sizes are large.

The high-speed interface 108 may manage bandwidth-intensive operations for the system 130, while the low-speed interface 112 and/or controller manages lower bandwidth-intensive operations. Such allocation of functions is exemplary only. In some embodiments, the high-speed interface 108 is coupled to memory 104, display 116 (e.g., through a graphics processor or accelerator), and to high-speed expansion ports 111, which may accept various expansion cards (not shown). In some embodiments, low-speed interface 112 and/or controller is coupled to storage device 106 and low-speed bus 114 (e.g., expansion port). The low-speed bus 114, which may include various communication ports (e.g., USB, Bluetooth, Ethernet, wireless Ethernet), may be coupled to one or more input/output devices, such as a keyboard, a pointing device, a scanner, and/or a networking device such as a switch or router (e.g., through a network adapter).

The system 130 may be implemented in a number of different forms, as shown in FIG. 1. For example, it may be implemented as a standard server or multiple times in a group of such servers. Additionally, or alternatively, the system 130 may be implemented as part of a rack server system, a personal computer, such as a laptop computer, and/or the like. Alternatively, components from system 130 may be combined with one or more other same or similar systems and the user input system 140 may be made up of multiple computing devices communicating with each other.

FIG. 1 also illustrates a user input system 140, in accordance with an embodiment of the invention. The user input system 140 may include a processor 152, memory 154, an input/output device such as a display 156, a communication interface 158, and a transceiver 160, among other components, such as one or more image sensors. The user input system 140 may also be provided with a storage device, such as a microdrive and/or the like, to provide additional storage. Each of the components 152, 154, 158, and 160, may be interconnected using various buses, and several of the components may be mounted on a common motherboard or in other manners as appropriate.

The processor 152 may be configured to execute instructions within the user input system 140, including instructions stored in the memory 154. The processor 152 may be implemented as a chipset of chips that include separate and multiple analog and/or digital processors. The processor 152 may be configured to provide, for example, for coordination of the other components of the user input system 140, such as control of user interfaces, applications run by user input system 140, and/or wireless communication by user input system 140.

The processor 152 may be configured to communicate with the user through control interface 164 and display interface 166 coupled to a display 156. The display 156 may be, for example, a Thin-Film-Transistor Liquid Crystal Display (TFT LCD) or an Organic Light Emitting Diode (OLED) display, and/or other appropriate display technology. An interface of the display 156 may include appropriate circuitry and may be configured for driving the display 156 to present graphical and other information to a user. The control interface 164 may receive commands from a user and convert them for submission to the processor 152. In addition, an external interface 168 may be provided in communication with processor 152 to enable near area communication of user input system 140 with other devices. External interface 168 may provide, for example, for wired communication in some implementations, or for wireless communication in other implementations, and multiple interfaces may also be used.

The memory 154 may store information within the user input system 140. The memory 154 may be implemented as one or more of a computer-readable medium or media, a volatile memory unit or units, or a non-volatile memory unit or units. Expansion memory may also be provided and connected to user input system 140 through an expansion interface (not shown), which may include, for example, a Single In Line Memory Module (SIMM) card interface. Such expansion memory may provide extra storage space for user input system 140 and/or may store applications and/or other information therein. In some embodiments, expansion memory may include instructions to carry out or supplement the processes described above and/or may include secure information. For example, expansion memory may be provided as a security module for user input system 140 and may be programmed with instructions that permit secure use of user input system 140. Additionally, or alternatively, secure applications may be provided via the SIMM cards, along with additional information, such as placing identifying information on the SIMM card in a secure manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In some embodiments, a computer program product may be tangibly embodied in an information carrier. The computer program product may contain instructions that, when executed, perform one or more methods, such as those described herein. The information carrier may be a computer-readable or machine-readable medium, such as the memory 154, expansion memory, memory on processor 152, and/or a propagated signal that may be received, for example, over transceiver 160 and/or external interface 168.

In some embodiments, the user may use the user input system 140 to transmit and/or receive information and/or commands to and/or from the system 130. In this regard, the system 130 may be configured to establish a communication link with the user input system 140, whereby the communication link establishes a data channel (wired and/or wireless) to facilitate the transfer of data between the user input system 140 and the system 130. In doing so, the system 130 may be configured to access one or more aspects of the user input system 140, such as, a GPS device, an image capturing component (e.g., camera), a microphone, a speaker, and/or the like.

The user input system 140 may communicate with the system 130 (and one or more other devices) wirelessly through communication interface 158, which may include digital signal processing circuitry. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

The user input system 140 may also communicate audibly using audio codec 162, which may receive spoken information from a user and convert it to usable digital information. Audio codec 162 may likewise generate audible sound for a user, such as through a speaker (e.g., in a handset) of user input system 140. Such sound may include sound from voice telephone calls, may include recorded sound (e.g., voice messages, music files, and/or the like) and may also include sound generated by one or more applications operating on the user input system 140, and in some embodiments, one or more applications operating on the system 130.

Various implementations of the systems and techniques described here may be realized in digital electronic circuitry, integrated circuitry, specially designed ASICs (application specific integrated circuits), computer hardware, firmware, software, and/or combinations thereof. Such various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and/or at least one output device.

Computer programs (e.g., also referred to as programs, software, applications, code, and/or the like) may include machine instructions for a programmable processor, and may be implemented in a high-level procedural and/or object-oriented programming language, and/or in assembly/machine language. As used herein, the terms “machine-readable medium” and/or “computer-readable medium” may refer to any computer program product, apparatus and/or device (e.g., magnetic discs, optical disks, memory, Programmable Logic Devices (PLDs), and/or the like) used to provide machine instructions and/or data to a programmable processor, including a machine-readable medium that receives machine instructions as a machine-readable signal. The term “machine-readable signal” may refer to any signal used to provide machine instructions and/or data to a programmable processor.

To provide for interaction with a user, the systems and/or techniques described herein may be implemented on a computer having a display device (e.g., a CRT (cathode ray tube), an LCD (liquid crystal display) monitor, and/or the like) for displaying information to the user, a keyboard by which the user may provide input to the computer, and/or a pointing device (e.g., a mouse or a trackball) by which the user may provide input to the computer. Other kinds of devices may be used to provide for interaction with a user as well. For example, feedback provided to the user may be any form of sensory feedback (e.g., visual feedback, auditory feedback, and/or tactile feedback). Additionally, or alternatively, input from the user may be received in any form, including acoustic, speech, and/or tactile input.

The systems and techniques described herein may be implemented in a computing system that includes a back end component (e.g., as a data server), that includes a middleware component (e.g., an application server), that includes a front end component (e.g., a client computer having a graphical user interface or a Web browser through which a user may interact with an implementation of the systems and techniques described here), and/or any combination of such back end, middleware, and/or front end components. Components of the system may be interconnected by any form or medium of digital data communication (e.g., a communication network). Examples of communication networks include a local area network (“LAN”), a wide area network (“WAN”), and/or the Internet.

In some embodiments, computing systems may include clients and servers. A client and server may generally be remote from each other and typically interact through a communication network. The relationship of client and server may arise by virtue of computer programs running on the respective computers and having a client-server relationship to each other.

The embodiment of the system environment 100 illustrated in FIG. 1 is exemplary and other embodiments may vary. As another example, in some embodiments, the system 130 includes more, less, or different components. As another example, in some embodiments, some or all of the portions of the system environment 100, the system 130, and/or the user input system 140 may be combined into a single portion. Likewise, in some embodiments, some or all of the portions of the system environment 100, the system 130, and/or the user input system 140 may be separated into two or more distinct portions.

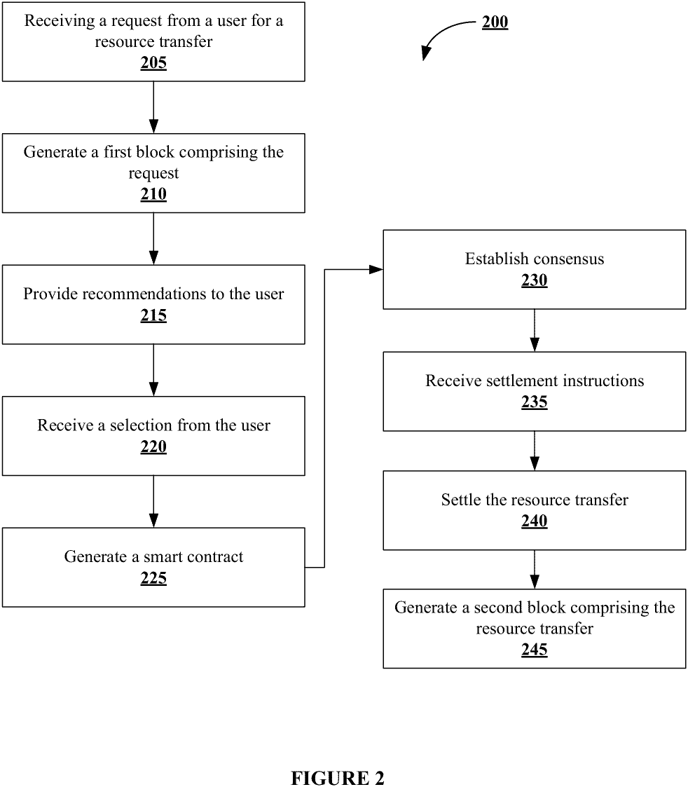

In some embodiments, the system environment 100 may include one or more user input systems and/or one or more electronic resource transfer system (e.g., similar to the system 130 and/or the user input system 140) associated with an entity (e.g., a business, a merchant, a financial institution, a card management institution, a software and/or hardware development company, a software and/or hardware testing company, and/or the like). For example, a user (e.g., an employee, a customer, and/or the like) may use a user input system (e.g., similar to the user input system 140) to initiate an electronic resource transfer (e.g., similar to the system 130, running a system similar to the system 130, and/or the like) and the user input system may provide information (identification, resource amount, account information, recipient information, etc.) to an electronic resource transfer system (e.g., similar to the system 130, running a system similar to the system 130, and/or the like). In some embodiments, the user input system and/or the electronic resource transfer system associated with the entity may perform one or more of the steps described herein with respect to the process flows described herein with respect to FIG. 2.

FIG. 2 illustrates a process flow 200 for electronic resource transfer, in accordance with an embodiment of the invention. In some embodiments, the electronic resource transfer system and/or the like (e.g., similar to one or more of the systems described herein with respect to FIG. 1) may perform one or more of the steps of process flow 200.

As shown in block 205, the process flow 200 may include receiving a request from a user for a resource transfer. In some embodiments, the request may be initiated via the user input system.

As shown in block 210, the process flow 200 may include generating a first block comprising the request. After generating the first block, the first block will be stored on a distributed ledger. In some embodiments, the first block may comprise one or more request details such as a requested resource amount, a requested resource origination, a requested resource destination, and a requested timeframe for the resource transfer.

As shown in block 215, the process flow 200 may include providing recommendations to the user. Recommendations are provided to the user via an auto-recommender engine.

As shown in block 220, the process flow 200 may include receiving a resource transfer quote selection from the user. The user will select the resource transfer quote that best fits their needs to continue with the transfer.

As shown in block 225, the process flow 200 may include generating a smart contract. In some embodiments, generating a smart contract further includes electronically executing the smart contract.

As shown in block 230, the process flow 200 may include establishing a consensus. In some embodiments, establishing a consensus comprises the nodes of the distributed ledger validating the resource transfer. Additionally, or alternatively, consensus is established through proof of work, stake, or raft.

As shown in block 235, the process flow 200 may include receiving settlement instructions from the user. In some embodiments, the user may provide standard settlement instructions.

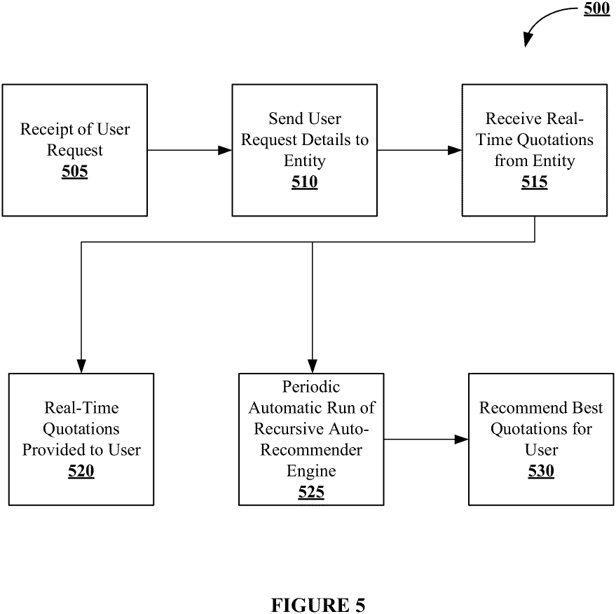

As shown in block 240, the process flow 200 may include settling the resource transfer. In some embodiments, settling the resource comprises the steps shown in FIG. 5. In some embodiments, the resource transfer is settled via auto-settlement. Additionally, or alternatively, the resource transfer is settled manually.

As shown in block 245, the process flow 200 may include generating a second block. The second block may comprise the resource transfer data. The second block may be stored on the distributed ledger. In some embodiments, resource transfer data comprises a resource transfer amount. Additionally, or alternatively, resource transfer data comprises a resource origination, wherein the resource origination is where the resource is being transferred from. In some embodiments, resource transfer data comprises a resource destination, wherein the resource destination is where the resource is being transferred to.

Process flow 200 may include additional embodiments, such as any single embodiment or any combination of embodiments described below and/or in connection with one or more other processes described elsewhere herein.

In a first embodiment, the process flow 200 may further comprise developing a user characterization. In some embodiments, the user characterization may comprise user information, and user account information. Additionally, or alternatively, as part of building the user characterization, the system may perform Know-Your-Customer (KYC) processes. In some embodiments, KYC processes may include identifying and verifying the user’s identity and credentials. In some embodiments, KYC processes may include a credit check of the user. In some embodiments, the user characterization comprises previously chosen resource transfer quotes. Additionally, or alternatively, the user characterization comprises previously resource transfer data.

In a second embodiment alone or in combination with the first embodiment, the auto-recommender engine utilizes a content-based filtering model. In some embodiments, the content-based filtering model recommends resource transfer quotes to a user based on the user’s activity and/or preference. In some embodiments, the content-based filtering model recommends resource transfer quotes to a user based on the attributes of the resource transfer quote and matches them to the user characterization. In some embodiments, the content-based filtering model utilizes a stored database. In some embodiments, the stored database comprises a quotation database.

In a third embodiment alone or in combination with any of the first through second embodiments, the auto-recommender engine utilizes a collaborative-based filtering model. In some embodiments, the collaborative-based filtering model recommends resource transfer quotes to users based on their similarity to other users who have chosen a resource transfer quote. In some embodiments, the collaborative-based filtering model predicts which resource transfer quote a user may chose based on that user’s similarity to other users. In some embodiments, the content-based filtering model utilizes a stored database. In some embodiments, the stored database comprises a user database, wherein the user database comprises user information. In some embodiments, user information comprises user KYC. Additionally, or alternatively, user information comprises the user’s past transactions. In some embodiments, user information comprises the user’s previously selected resource transfer quotes.

In a fourth embodiment alone or in combination with any of the first through third embodiments, the auto-recommender engine utilizes a hybrid filtering model. In some embodiments, the hybrid filtering model combines both content-based filtering and collaborative-based filtering to recommend resource transfer quotes to the user. In a hybrid filtering model, the auto-recommender engine will utilize more than one database. In some embodiments, the hybrid filtering model may utilize a user database. Additionally, or alternatively, the hybrid filtering model may utilize a quotation database.

In a fifth embodiment alone or in combination with any of the first through fourth embodiments, wherein the auto-recommender engine comprises a user database. In some embodiments, the user database comprises a list of users, user characterizations, and users previously chosen resource transfer quotes. Additionally, or alternatively, the auto-recommender engine comprises a quotation database. In some embodiments, the quotation database comprises a list of resource transfer quotes and resource transfer quote attributes. In some embodiments, resource transfer quote attributes may include resource transfer rates and settlement timeframes. In some embodiments, user characterization details are stored on one or both databases. Additionally, or alternatively, resource transfer provider (or entity) details are stored on one or both databases. In some embodiments, a resource transfer rates are stored on one or both databases. Additionally, or alternatively, settlement times are stored on one or both databases. In some embodiments, resource transfer rate validity is stored on one or both databases. Additionally, or alternatively, smart contract validity is stored on one or both databases. In some embodiments, user feedback for entities is stored on one or both databases. Additionally, or alternatively, entity feedback for users is stored on one or both databases.

In a sixth embodiment alone or in combination with any of the first through fifth embodiments, the auto-recommender engine utilizes quantum computing to provide recommendations to the user. In some embodiments, the auto-recommender engine is coupled to a quantum computer. Additionally, or alternatively, the auto-recommender node operates on a quantum computer.

In a seventh embodiment alone or in combination with any of the first through sixth embodiments, the auto-recommender engine self-evaluates the recommendations generated by the recommendation models: content-based, collaborative-based, or hybrid models. Additionally, or alternatively, the auto-recommender engine self-evaluates the recommendations based on historical recommendation data.

In an eighth embodiment alone or in combination with any of the first through seventh embodiments, the resource transfer quote comprises a settlement rate. The settlement rate determines the rate at which the resource transfer occurs. Additionally, or alternatively, the resource transfer quote comprises a settlement time. The settlement time is the time it takes to settle the resource transfer. Additionally, or alternatively, the resource transfer quote comprises an expiration date for the quote. The expiration date is the date at which the resource transfer quote expires and is no longer an available option for the user’s resource transfer. In some embodiments, the resource transfer quote may include any number of other stipulations related to the resource transfer.

In a ninth embodiment alone or in combination with any of the first through eighth embodiments, the process flow 200 further comprises receiving resource transfer quotes from at least one entity. In some embodiments, the system may send a request to an entity (or entities) for resource transfer quotes for the user. In some embodiments, this request comprises information from the user characterization. Additionally, or alternatively, the system will receive resource transfer quotes from the entity (or entities). In some embodiments, the system will send the resource transfer quotes to the auto-recommender engine. The auto-recommender engine will utilize a filtering model (or models) to recommend resource transfer quotes to the user.

In a tenth embodiment, alone or in combination with any of the first through ninth embodiments, the distributed ledger system is a blockchain. Additionally, or alternatively, the distributed ledger system is a hash-graph. In some embodiments, the distributed ledger system is the system described in US16/717170, which is hereby incorporated by reference.

In an eleventh embodiment, alone or in combination with any of the first through tenth embodiments, the system described herein is used for the exchange of one currency to another currency. Additionally, or alternatively, the system may be used for the exchange of national currencies.

Although FIG. 2 shows example blocks of process flow 200, in some embodiments, process flow 200 may include additional blocks, fewer blocks, different blocks, or differently arranged blocks than those depicted in FIG. 2. Additionally, or alternatively, two or more of the blocks of process flow 200 may be performed in parallel.

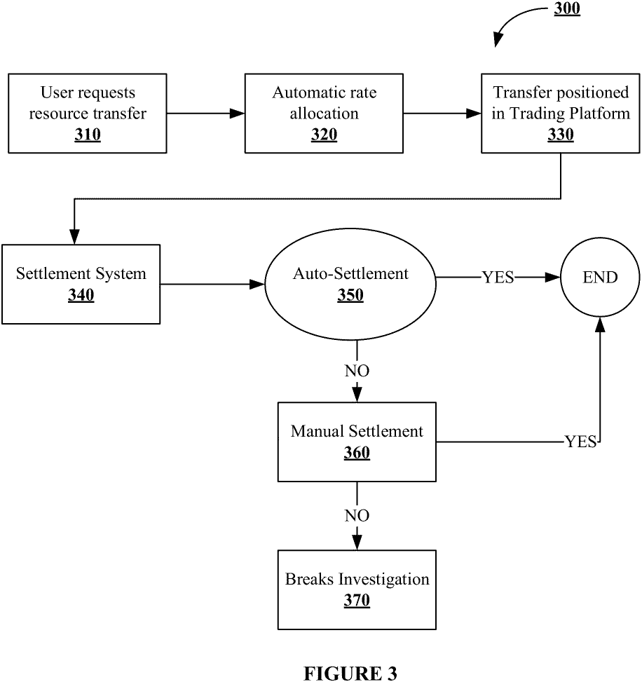

FIG. 3 illustrates a flow diagram for electronic resource transfer, in accordance with previous electronic resource transfer systems. In these systems, the user requests a resource transfer, 310. The system will automatically allocate a rate for the user, 320. The resource transfer will be positioned in the trading platform for settlement, 330. At this point, the resource transfer may be settled, 340. The system may perform an auto-settlement, 350. If the auto-settlement is successful 355, the resource transfer is completed. If not, the system will manually settle the resource transfer, 360. If the manual settlement is successful 365, the resource transfer is completed. If the manual settlement is unsuccessful, the investigation will be broken 370.

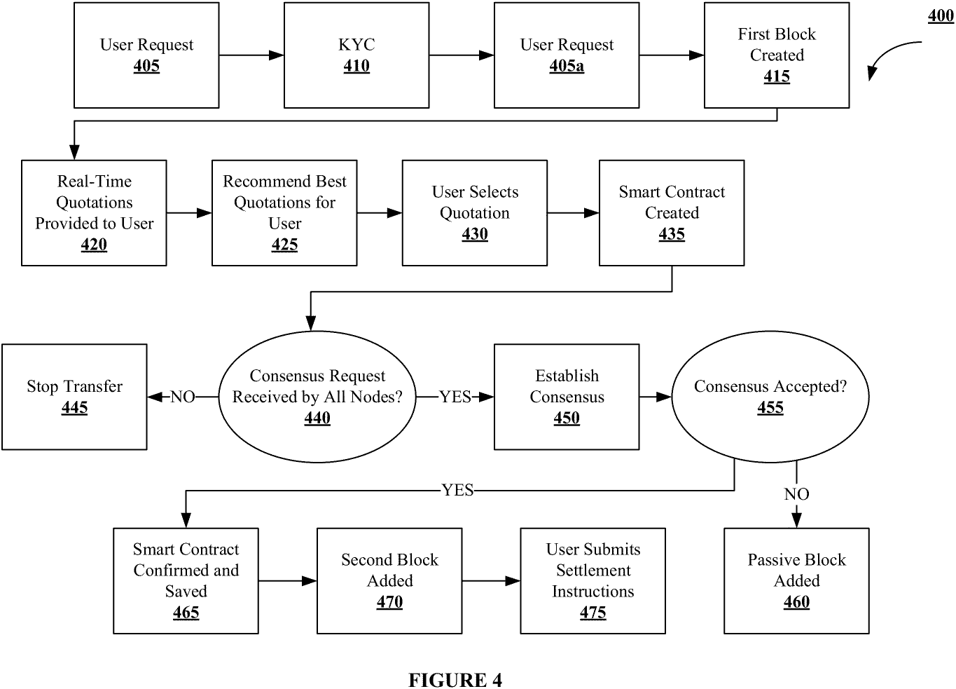

FIG. 4 illustrates a flow diagram for electronic resource transfer, in accordance with an embodiment of the invention. The system receives a user request 405 for an account. This step is optional, for example, if the user already has an account with the system. The system performs KYC-analysis on the user 410. The system receives a second user request 405a for a resource transfer. The system creates a first block 415 containing the user request details. The first block is stored on the distributed ledger. In some embodiments, the user request details may comprise the user characterization. In some embodiments, the user request details may comprise the resource transfer amount. In some embodiments, the user request details may comprise the resource transfer destination. In some embodiments, the user request details may comprise the resource transfer origination. In some embodiments, the user request details may comprise the KYC analysis for the user.

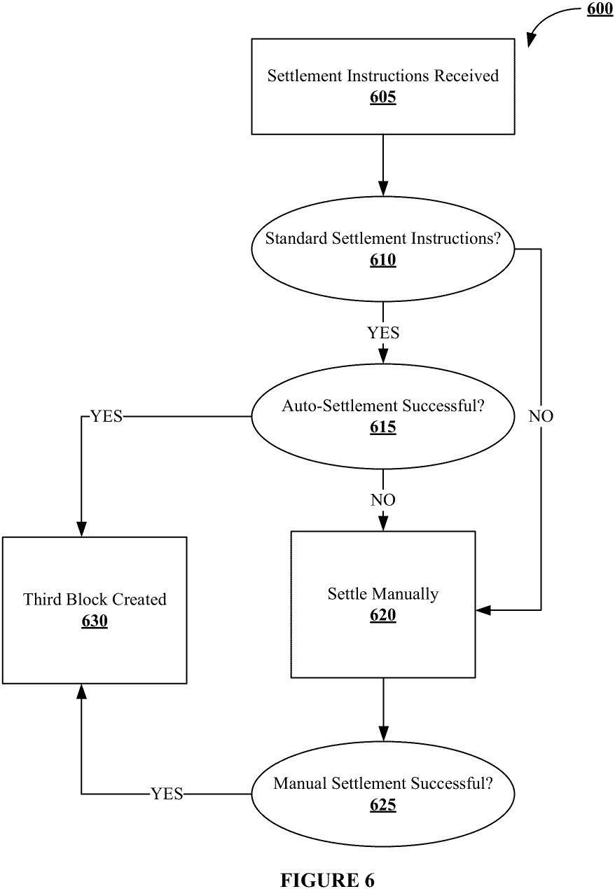

As shown in FIG. 4, the system will provide real-time quotations to the user 420. The system will recommend the best quotations for the user 425. These recommendations may be generated by the auto-recommender engine. Once the user selects a resource transfer quotation 430 to use for their resource transfer, the system will create a smart contract 435. The system will send a consensus request to all nodes in the distributed ledger 440, if the consensus request is received the system will establish a consensus 450. If the consensus request is not received, the system will stop the transfer 445. If the consensus is accepted by all nodes, the smart contract is confirmed and saved 465. A second block is created 470 and added to the distributed ledger, the second block comprises the smart contract. The user will submit settlement instructions 475, and the resource transfer will be settled according to those instructions via the process represented in FIG. 6. If the consensus is not accepted, a passive block will be added to the distributed ledger 460. The passive block is added for consistency purposes.

FIG. 5 illustrates a flow diagram for providing real-time quotations, in accordance with an embodiment of the invention. Once the system receives the user request 505, the system will send the request details to the entity, or entities 510. The system will receive real-time quotations from the entity, or entities 515. The system may provide the real-time quotations to the user 520. The system will run the real-time quotations through the auto-recommender engine 525 and present the recommended quotations to the user 530. In some embodiments, the system will identify a best suitable recommendation model through which a best quote recommendation may be provided to a user.

FIG. 6 illustrates a flow diagram for electronic resource settlement, in accordance with an embodiment of the invention. The system will receive settlement instructions from the user 605. The system will determine if the settlement instructions are standard 610. If the settlement instructions are determined to be standard, the system will attempt auto-settlement 615. If the settlement instructions are determined not to be standard, the system will attempt to settle manually 620. If auto-settlement is determined to be successful, a third block is created 630, the third block containing the settlement information. The third block may be stored on the distributed ledger. If the auto-settlement is determined to not be successful, the system will attempt to settle manually 620. Once the manual settlement is determined to be successful 625, the system will create the third block for the resource transfer and store the third block on the distributed ledger.

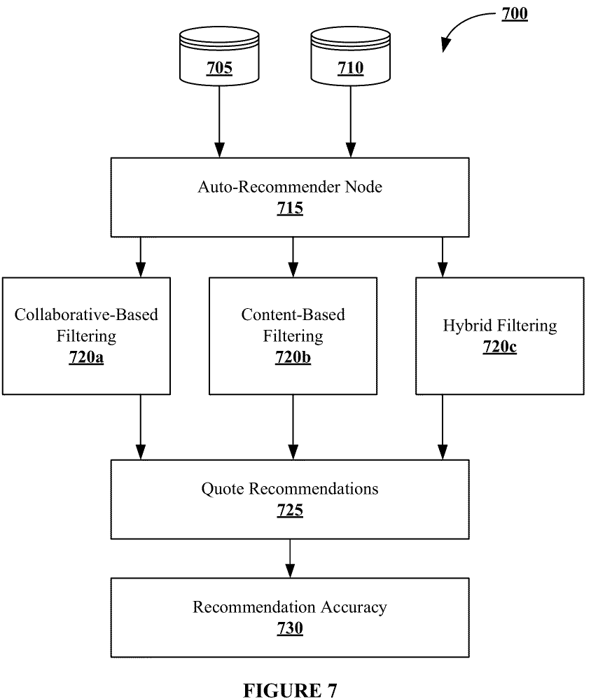

FIG. 7 illustrates an exemplary schematic for the auto-recommender engine, in accordance with an embodiment of the invention. The system may maintain a database(s) 705 for the auto-recommender engine. In some embodiments, there is one database. Additionally, or alternatively, there are multiple databases. In some embodiments, the database(s) comprise at least one database comprising user information. Additionally, or alternatively, the database(s) comprise at least one database comprising quotation information. In some embodiments, the database(s) comprise at least one database comprising entity information. For example, and as shown in FIG. 7, the system may maintain a first database 705 that includes a distributed ledger of data of previous trading by the user a second database 710 that includes quotation data from financial institutions and resource distribution processing service providers (e.g., including parameters such as Forex rate, settlement time, Forex rate validity, and/or the like).

As shown in FIG. 7, the auto-recommender engine comprises an auto-recommender node 715. The auto-recommender node 715 utilizes database(s) 705 to generate recommendations and recommend resource transfer quotes to users. In some embodiments, the auto-recommender node 715 may use collaborate-based filtering 720a to recommend resource transfer quotes to a user. Additionally, or alternatively, the auto-recommender node 715 may use content-based filtering 720b to recommend a resource transfer quote to users. In some embodiments, the auto-recommender node 715 may use hybrid filtering 720c to recommend a resource transfer quote to a user. Once the auto-recommender node 715 has performed the chosen filtering method, the system will present the user with quote recommendations 725. The auto-recommender engine will determine the recommendation accuracy 730 of each filtering method using historical data to determine the best recommendation model.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that may direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments may be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| U.S. Pat. Application Ser. No. | Title | Filed On |
|---|---|---|
| 16/717,170 | SYSTEM FOR TRACKING RESOURCES IN A DISTRIBUTED ENVIRONMENT | Dec. 17, 2019 |

What is claimed is:

1. A system for electronic resource transfer, the system comprising
at least one non-transitory storage device, and
at least one processing device coupled to the at least one non-transitory storage device, wherein the at least one processing device is configured to:
receive a request, from a user, to transfer resources;
create a first block, wherein the first block comprises request data, wherein the first block is stored on a distributed ledger;
receive, from at least one entity, a resource transfer quote;
provide recommendations to the user, wherein the recommendations comprise at least one of the resource transfer quotes to the user, wherein the recommendations are generated by a recursive auto-recommender engine, wherein the recursive auto-recommender engine is stored on an auto-recommender node within the distributed ledger;
receive a resource transfer quote selection from the user,
create a smart contract, wherein the smart contract is stored on the distributed ledger;
establish a consensus amongst nodes of the distributed ledger;
receive settlement instructions from the user;
settle the resource transfer according to the settlement instructions; and
create a second block, wherein the second block comprises resource transfer data,
wherein the second block is stored on the distributed ledger.

2. The system for electronic resource transfer according to claim 1, wherein the at least one processing device is further configured to develop a user characterization.

3. The system for electronic resource transfer according to claim 1, wherein the recursive auto-recommender engine is configured to:
generate recommendations using a content-based filtering model, a collaborative-based filtering model, and a hybrid filtering model; and
evaluate accuracy of each filtering method using historical data from the distributed ledger.

4. The system for electronic resource transfer according to claim 1, wherein the auto-recommender node comprises at least one of a user database and a quotation database, wherein the user database comprises a distributed ledger.

5. The system for electronic resource transfer according to claim 1, wherein the auto-recommender node is powered by quantum computing.

6. The system for electronic resource transfer according to claim 1, wherein the resource transfer data comprises an amount, an origination, and a destination.

7. The system for electronic resource transfer according to claim 1, wherein the resource transfer quote comprises at least one of a settlement rate, a settlement time, and an expiration date.

8. A computer program product for electronic resource transfer, the computer program product comprising a non-transitory computer-readable medium comprising code causing a first apparatus to:
receive a request, from a user, to transfer resources;
create a first block, wherein the first block comprises request data, wherein the first block is stored on a distributed ledger;
receive, from at least one entity, a resource transfer quote;
provide recommendations to the user, wherein the recommendations comprise at least one of the resource transfer quotes to the user, wherein the recommendations are generated by a recursive auto-recommender engine, wherein the recursive auto-recommender engine is stored on an auto-recommender node within the distributed ledger;
receive a resource transfer quote selection from the user,
create a smart contract, wherein the smart contract is stored on the distributed ledger;
establish a consensus amongst nodes of the distributed ledger;
receive settlement instructions from the user;
settle the resource transfer according to the settlement instructions; and
create a second block, wherein the second block comprises resource transfer data, wherein the second block is stored on the distributed ledger.

9. The computer program product for electronic resource transfer according to claim 8, wherein the non-transitory computer-readable medium further comprises code causing the first apparatus to develop a user characterization.

10. The computer program product for electronic resource transfer according to claim 8, wherein the recursive auto-recommender engine is configured to:
generate recommendations using a content-based filtering model, a collaborative-based filtering model, and a hybrid filtering model; and
evaluate accuracy of each filtering method using historical data from the distributed ledger.

11. The computer program product for electronic resource transfer according to claim 8, wherein the auto-recommender node comprises at least one of a user database and a quotation database.

12. The computer program product for electronic resource transfer according to claim 8, wherein the auto-recommender node utilizes quantum computing.

13. The computer program product for electronic resource transfer according to claim 8, wherein the resource transfer data comprises an amount, an origination, and a destination.

14. The computer program product for electronic resource transfer according to claim 8, wherein the resource transfer quote comprises at least one of a settlement rate, a settlement time, and an expiration date.

15. A method for electronic resource transfer, the method comprising:
receiving a request, from a user, to transfer resources;
creating a first block, wherein the first block comprises request data, wherein the first block is stored on a distributed ledger;
receiving, from at least one entity, a resource transfer quote;
providing recommendations to the user, wherein the recommendations comprise at least one of the resource transfer quotes to the user, wherein the recommendations are generated by a recursive auto-recommender engine, wherein the recursive auto-recommender engine is stored on an auto-recommender node within the distributed ledger;
receiving a resource transfer quote selection from the user,
creating a smart contract, wherein the smart contract is stored on the distributed ledger;
establishing a consensus amongst nodes of the distributed ledger;
receiving settlement instructions from the user;
settling the resource transfer according to the settlement instructions; and
creating a second block, wherein the second block comprises resource transfer data, wherein the second block is stored on the distributed ledger.

16. The method for electronic resource transfer according to claim 15, wherein the method further comprises developing a user characterization.

17. The method for electronic resource transfer according to claim 15, wherein the recursive auto-recommender engine:
generates recommendations using a content-based filtering model, a collaborative-based filtering model, and a hybrid filtering model; and
evaluates accuracy of each recommendation using historical data.

18. The method for electronic resource transfer according to claim 15, wherein the method further comprises utilizing quantum computing within the recursive auto-recommender engine.

19. The method for electronic resource transfer according to claim 15, wherein the resource transfer data comprises an amount, an origination, and a destination.

20. The method for electronic resource transfer according to claim 15, wherein the resource transfer quote comprises at least one of a settlement rate, a settlement time, and an expiration date.
